(19) United States
(12) Patent Application Publication
(10) Pub. No.: US 2023/0074367 A1
(43) Pub. Date: Mar. 9, 2023

(54) JAR SENSORS FOR FOOD PRESERVATION

(71) Applicant: National Presto Industries, Inc., Eau Claire, WI (US)

(72) Inventor: Douglas J. Frederick, Eau Claire, WI (US)

(21) Appl. No.: 17/940,735

(22) Filed: Sep. 8, 2022

Related U.S. Application Data
(60) Provisional application No. 63/241,906, filed on Sep. 8, 2021.

(51) Int. Cl. A47J 41/00; G01K 13/00; G01K 1/14; H04B 11/00

(52) U.S. Cl. CPC A47J 41/0094; G01K 13/00; G01K 1/14; H04B 11/00; A47J 2202/00

(57) ABSTRACT

Disclosed is a system for canning foodstuffs that provides precise monitoring of the temperature of the contents of each canning jar during a canning process. The system may include user interface displays that provide prompts to the user regarding the canning process. Configurations of the system can include temperature receivers that include displays which prompt the user to perform certain steps in the canning process. Other configurations can include interfaces that control heat sources such that the heat source can be controlled by the system without user interaction during the canning process. Still other configurations interact with the canner to regulate pressure inside the canner to further decrease the level of interaction with a user.

### CROSS REFERENCE TO RELATED APPLICATIONS

This application claims priority to U.S. Provisional application 63/241,906 filed on Sep. 8, 2021 which is incorporated herein by reference in its entirety.

### TECHNICAL FIELD

The present invention is directed to the field of food preservation devices and methods. More specifically, the invention is directed to devices for more accurately measuring the conditions inside a canning vessel during a canning process.

### BACKGROUND

Canning has long been used to preserve foods by sterilizing the foodstuffs with heat and sealing them in a container. While canning is often performed on a commercial scale, canning is also frequently performed in home kitchens. While the canning method of food preservation is safe when performed properly, it is extremely important to follow recommended procedures carefully. The United States Department of Agriculture (USDA) offers a detailed guide entitled “Complete Guide to Home Canning”, the edition current with the time of filing this patent application being dated 2015, is incorporated herein by reference. Persons home canning foodstuffs are encouraged to closely follow the guidance provided by the USDA.

There are generally two types of canning procedures performed by home canners. The first is boiling water canning. Because the temperatures attained by boiling water canning are necessarily limited by the boiling point of water at the local elevation, boiling water canning is only appropriate for canning acidic foods such as fruits and certain tomatoes. Other foods that are less acidic such as corn, beans, and squash require higher levels of heat than can ordinarily be provided by boiling water. The boiling point of water is raised when in a pressurized environment, thus, pressure canning is a method of achieving the necessary temperatures required to process low acid foods. Pressure canning involves placing food into containers (commonly referred to as “jars” because non-commercial canning generally uses glass jars). These jars are placed into a container with water. A lid is placed on the container and heat is added to achieve a certain temperature (those temperatures are made possible because of the pressurized container). A process of heating and cooling the jars is then carefully followed. Failing to carefully follow the procedure can result in unsafe canned foodstuffs. Generally, failing at any one step requires that the process be restarted from the beginning. Electronically controlled canning systems such as the Presto Precise® Digital Pressure Canner monitor the canning process and prompt the user to perform the various steps. Some of these steps follow USDA guidance and thus involve waiting for predefined time periods intended to ensure that the foodstuffs in the jars reach certain temperatures. These times are based on the process performed when using a conventional stovetop canner. However, the process performed by a digital canner could be much more efficient than the conventional process if more accurate temperature values could be obtained during the canning process. What is needed is a system for monitoring the temperature of foodstuffs being canned and a method of controlling the canning process using the temperature monitoring system.

### SUMMARY

A device for canning foodstuffs according to an exemplary embodiment comprises at least one jar lid with a probe chamber formed in the jar lid, at least one interface module, and a receiver. The interface module is in electrical communication with a temperature sensor disposed in the probe chamber, the interface module is configured to transmit a signal to a receiver, the receiver comprising a processor and instructions that when executed by the processor, cause the processor to process the received signal to determine a temperature of the temperature sensor, determine if the received temperature is within a desired temperature range, and display a user prompt on a user interface which indicates an action to be performed in a canning process.

A method of canning according to an exemplary embodiment comprising the steps of applying a jar lid to a canning jar, the jar lid comprising a probe chamber having a temperature sensor disposed therein, applying an interface module to the jar lid, causing the interface module to be in electronic communication with a receiver, the receiver comprising a user interface, receiving temperature sensor data using the interface module, transmitting the received temperature sensor data by the interface module, receiving the transmitted temperature data by the receiver, and displaying action prompts using the user interface, where such action prompts are determined by the temperature data and time data and related to a canning process.

A device for canning foodstuffs according to an exemplary embodiment comprising at least one jar lid having an upper and lower surface with a probe chamber formed in the jar lid, the probe chamber extending axially from a lower surface of the jar lid, the probe chamber formed such that a probe chamber of a first jar lid is insertable into a probe chamber of a second jar lid to enable stacking of the first and second jar lids for storage. At least one interface module removably affixable to the jar lid, the interface module comprises a rechargeable battery and an inductive receiver in electrical communication with a battery charging electronic circuit which charges the battery, the interface module is in electrical communication with a temperature sensor disposed in the probe chamber, the interface module transmits a signal to a receiver which receives the signal, the receiver comprising a processor and instructions that when executed by the processor, cause the processor to process the received signal to determine a temperature of the temperature sensor, determine if the received temperature is within a desired temperature range, and display a user prompt on a user interface which indicates an action to perform in a canning process.

The above summary is not intended to describe each illustrated embodiment or every implementation of the invention. Rather, the exemplary embodiments are chosen and described so as to provide an overview or framework for understanding the nature and character of the claimed aspects and implementations so that those skilled in the art can appreciate and understand the principles and practices of the invention. The Figures and the detailed description that follow more particularly exemplify these exemplary embodiments, and are incorporated in and constitute a part of this specification.

### BRIEF DESCRIPTION OF THE DRAWINGS

These and other features and advantages of the present invention will become better understood with regard to the following description and accompanying drawings in which:

FIG. 1 is an exploded diagram of a known canning jar and lid assembly;

FIG. 2 is a cutaway view of a canning jar lid according to an exemplary embodiment;

FIG. 3 is a cutaway view of a canning jar lid according to an exemplary embodiment;

FIG. 4A is a cutaway view of a canning jar lid according to an exemplary embodiment;

FIG. 4B is a cutaway view of the canning jar lid of FIG. 4A shown in an alternate configuration;

FIG. 5 is a diagram of a canning jar lid and sensor assembly according to an exemplary embodiment;

FIG. 6 is a block diagram of the sensor assembly of FIG. 5;

FIG. 7 is a diagram of jars configured with canning jar lids and sensors according to an exemplary embodiment;

FIG. 8 is a diagram of jars configured with canning jar lids and sensors according to another exemplary embodiment;

FIG. 9 is a diagram of jars configured with canning jar lids and sensors according to yet another exemplary embodiment;

FIG. 10 is a block diagram of the sound receiver assembly of FIG. 9; and

FIG. 11 is a flow diagram of the steps taken in an exemplary embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Not properly performing the canning process could result in contaminated or unsafe foodstuffs. Therefore, the reader is encouraged to follow the USDA's guidance regarding canning as a method of food preservation.

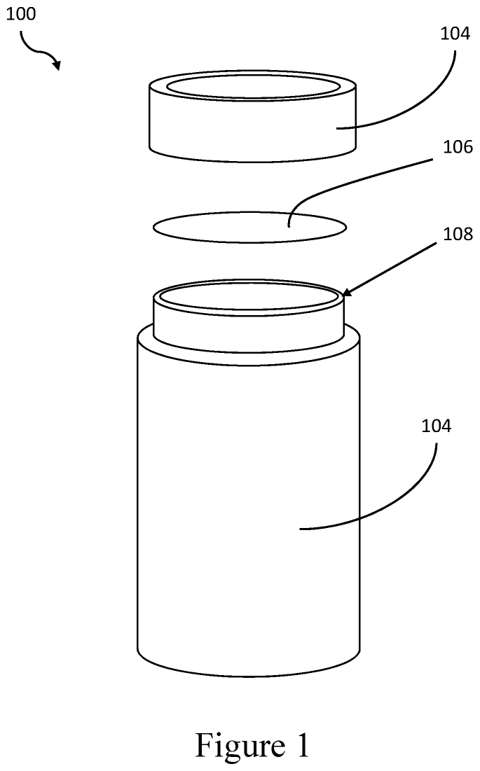

A known embodiment of a canning jar assembly 100 is illustrated in FIG. 1. Shown is a canning jar 102, a screw band 104, and a lid 106. During the canning process, foodstuffs are placed in the canning jar 102 with a necessary amount of liquid, the lid 106 is placed on the upper lip 108 of the canning jar 102 and the screw band 104 is loosely tightened to hold the lid 106 in contact with the upper lip 108 of the canning jar 102. As is described in the “Complete Guide to Home Canning”, published by the United States Department of Agriculture (revised in 2015), there are various steps necessary for safe canning but for ease of explanation, it is presumed that the reader understands that these steps are required. As will be illustrated later herein, lid 106 comprises a sealing ring formed along the bottom perimeter of the lid 106 such that the sealing ring (not shown) makes contact with the upper lip 108 of the canning jar 102. During the canning process, this sealing ring is drawn against the upper lip 108 of the canning jar 102 via a vacuum formed inside the canning jar 102 as it cools, forming a seal between the lid 106 and the canning jar 102 to prevent contamination of the contents of the canning jar 102. When canning, foodstuffs are placed in the canning jar 102 leaving a space between the jar lid. Generally the foodstuffs are positioned such that foodstuffs are not in contact with the lid material.

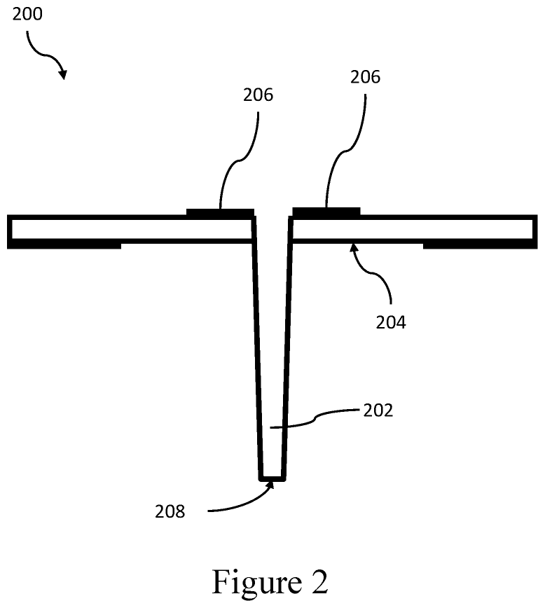

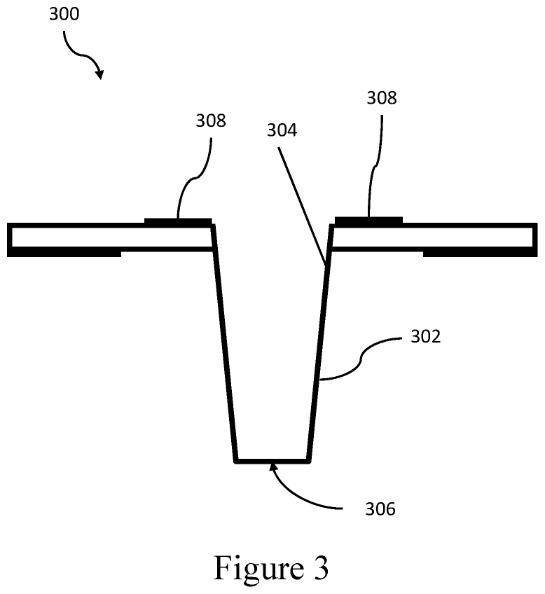

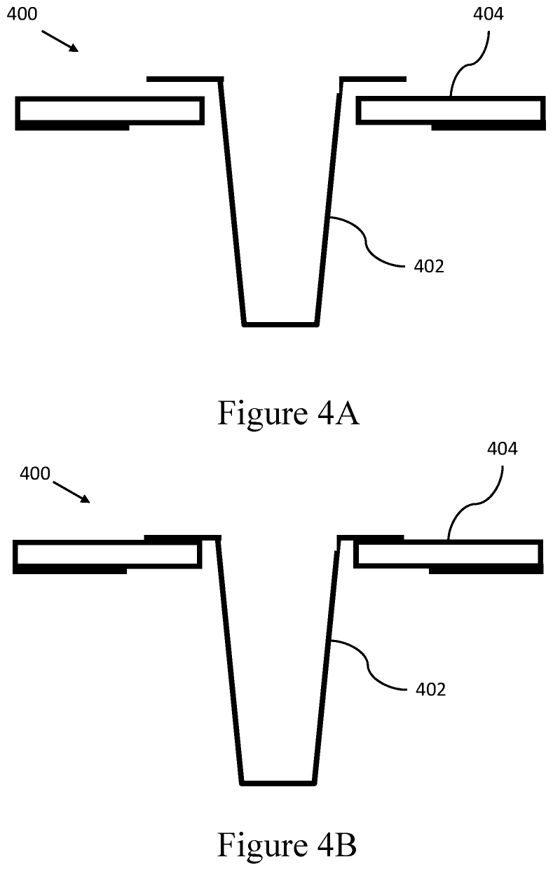

In order to ensure that the foodstuffs in a canning jar 102 are heated to the correct temperature and held consistently at that temperature, temperatures of the foodstuff are monitored directly by exemplary embodiments. Monitoring foodstuffs directly ensures that the necessary temperatures are attained and maintained for the time periods specified by various canning recipes. As was noted with reference to FIG. 1, the headspace requirements result in a space between the lid 106 and the foodstuff. As is shown in FIG. 2, in an exemplary embodiment, a probe 202 is formed in the jar lid 200. The probe 202 projects downward from the lower surface 204 of the jar lid 200 such that the probe 202 contacts the foodstuffs or liquid contained in the jar. Conventional lids 106 also include a slight dome-shaped deformation in the jar lid. This deformation is drawn into the canning jar 102 during the canning process and serves a safety function in that the dome shaped-deformation “pops up” if there is a loss of vacuum in the jar. Such a loss of vacuum would indicate that the seal between the lid 106 and canning jar 102 has failed. This deformation 206 is formed in the jar lid 200 of FIG. 2 to provide a similar safety indicator. FIG. 3 illustrates an alternative embodiment of a jar lid 300 in which a probe 302 is formed that is wider at its top portion 304 than the probe 202 of FIG. 2. This wider top portion 304 permits multiple jar lids 300 to be stacked with the probe 302 of a first jar lid 300 nesting with a probe 302 of an adjacent lid 300 in the stack. Thus, a plurality of jar lids 300 can be packaged in a smaller shipping and storage box than would be required should a probe configuration not allow for stacking of the jar lids. The probe 302 is illustrated as having a wider tip portion 306 than the tip portion 208 of the probe 202 of FIG. 2. Exemplary embodiments may also have a narrower tip depending upon the type of temperature sensor selected and available lid materials and tooling. The exemplary lid 300 of FIG. 3 is also configured with a deformation 308 that performs the safety function discussed with regard to FIG. 2. FIGS. 4A and 4B illustrate a two-piece lid embodiment 400 in which the probe 402 is formed separately from the upper lid. As shown in FIG. 4B, the probe 402 is affixed to the upper lid surface 404 prior to use. In other embodiments, the probe may be affixed to the lower lid surface prior to use. The probe may be affixed by various methods including, but not limited to, adhesives, welding, or a seal and vacuum action similar to what is used to secure lids 106, 200, 300, and the lid 400 to the upper lip 108 of a canning jar 102. In such embodiments, the deformation may be found in the jar lid or a portion of the probe.

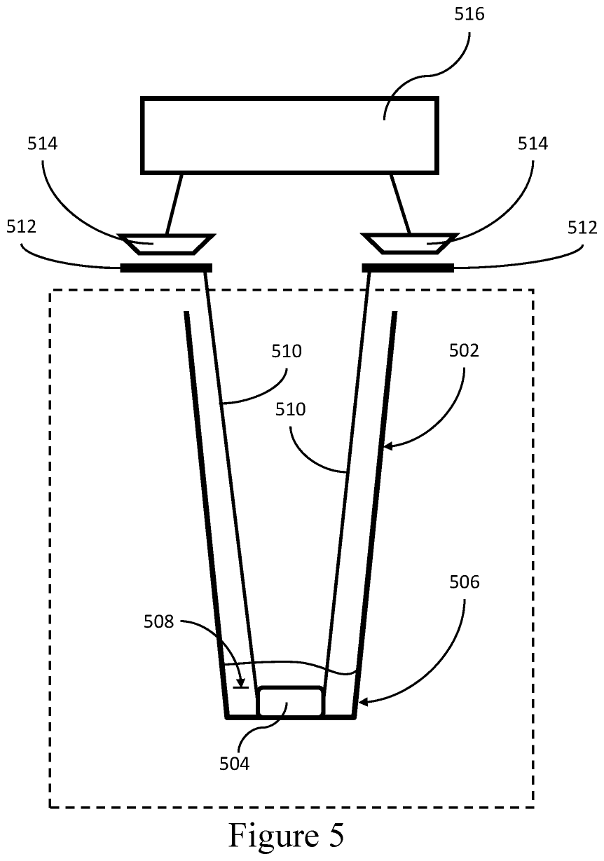

FIG. 5 illustrates an exemplary embodiment of a probe 502 in which a temperature sensor 504 has been installed. In the exemplary embodiment, the temperature sensor 504 has been “potted” in the tip portion 506 of the probe 502 using a temperature conductive epoxy material 508. Other adhesives can be used so long as they do not substantially interfere with the transfer of heat from the tip portion 506 to the temperature sensor 504. In other embodiments, the temperature sensor 504 can be held in place with a clip (not shown), or sized so that the temperature sensor 504 is held in place via an interference fit between the inner surface of the probe 502 and the temperature sensor 504.

Various temperature sensor types can be used in exemplary embodiments. For example, without limitation, the temperature sensor may be a thermocouple, a thermistor, or an active semiconductor sensor. Electrical connections 510 extend from the temperature sensor 504 to contact pads 512. Although two electrical connections 510 are illustrated, certain temperature sensors (particularly active semiconductor sensors) may have a greater or lesser number of electrical connections 510. In certain exemplary embodiments, the contact pads 512 are located on the upper surface of the jar lid. In such embodiments, receiver pads 514 form an electrical connection with the contact pads 512 when an interface module 516 is mounted to a jar lid. As will be described herein, the interface module functions to communicate temperatures experienced by the temperature sensor to a receiver for notification of a user or further processing. In certain exemplary embodiments, the interface module 516 is affixed to the jar lid 300 with magnets, clips, a friction fit into a shaft of the probe 502, or other similar means which secures the interface module 516 such that the receiver pads 514 are held securely against the contact pads 512 in order that an electrical connection is formed therebetween. In certain exemplary embodiments, the interface module 516 may be formed such that it includes a threaded portion that acts as a screw band 104 during a processing portion of the canning process. This has the advantage of securing the jar lid 300 to the canning jar 102 as well as maintaining an electrical connection between the receiver pads 514 of the interface module 516 with the contact pads 512 of the jar lid 300. When the interface module 516 is in electrical contact with the temperature sensor 504, signals from the temperature sensor 504 are able to be received by the interface module 516 without risk of interruption even when the canning jar is placed into a pressure canning vessel.

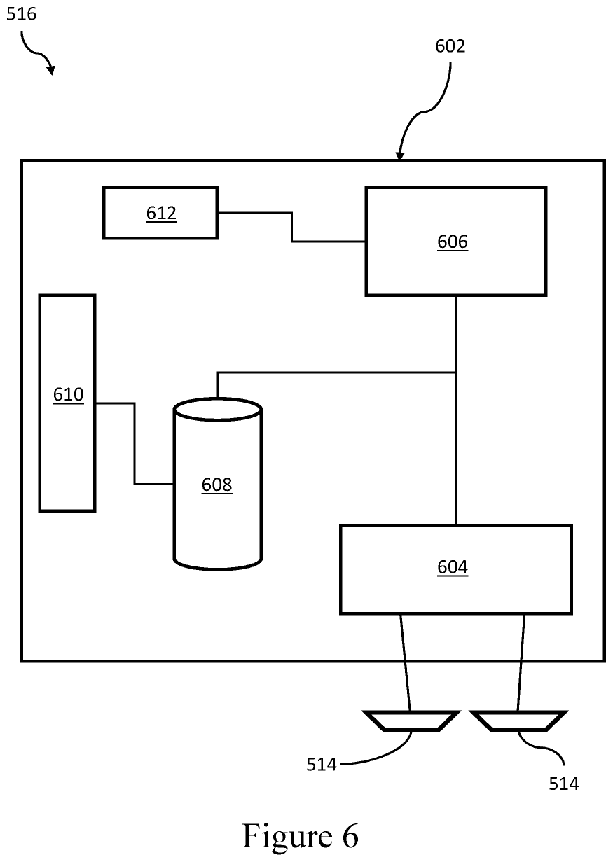

The interface module 516 comprises components that receive temperature data from the temperature sensor and store or communicate the received data to one or more receivers for processing. A block diagram of an exemplary interface module 516 is shown in FIG. 6. Because the interface module is intended to be used with pressure canning equipment, certain exemplary embodiments of the interface module are configured with an enclosure 602 that is watertight and sufficiently heat resistant to protect the electronics surrounded by the enclosure 602 from damage. In exemplary embodiments, the enclosure 602 is formed from materials such as, without limitation, stainless steel, durable plastics, or other materials that provide sufficient protection from heat and moisture.

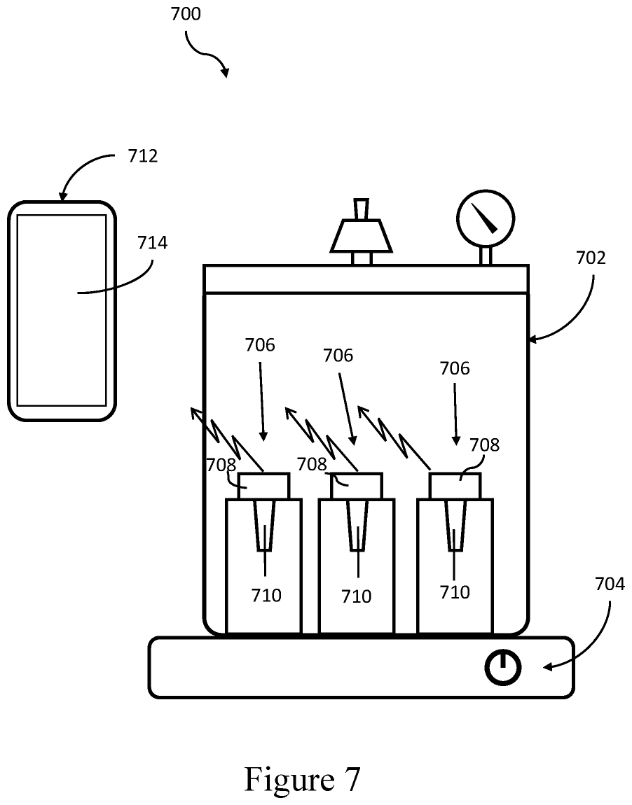

An exemplary embodiment of an interface module 516 comprises receiver pads 514 which are in electronic communication with an input interface 604. When in use, the input interface 604 is configured to receive signals from the temperature sensor 504 for processing. In an exemplary embodiment, the input interface 604 provides electrical protection to other electronic components of the interface module 516 such that these other components are not damaged by excess voltage or current. The input interface 604 may also perform a pre-processing function such as filtering out any electronic interference. The interface module may also amplify or attenuate the signal from the temperature sensor 504 to voltage levels that are appropriate for a processor 606. The processor 606 receives the signals from the temperature sensor after those signals have been processed by filtering, amplification/attenuation, or both. The processor then performs any necessary filtering and conversion (such as interpreting data from a digital sensor, or receiving an analog voltage from a thermocouple, or measuring the resistance of a resistive temperature sensor) to provide a signal representing a temperature measured by the temperature sensor 504. After conversion, certain exemplary embodiments may store the received information in a memory which may be integral to the processor 606 or a separate component. Other exemplary embodiments may convert the received data into a radio frequency signal and transmit the data to a receiver. In exemplary embodiments, the data may be transmitted using standard transmission protocols such as Bluetooth®, WiFi®, or other wireless personal area networks. Certain exemplary embodiments may utilize other technologies such as sound, light, or magnetic pulses where such technologies may provide improved communication through materials used in the housings of pressure canners. Because the interface module 516 is sealed inside the enclosure 602 in certain exemplary embodiments, a source of power is included in such embodiments. In the exemplary embodiment shown, a battery 608 is in electronic communication with the processor 606 and input interface 604. In the illustrated embodiment, the battery 608 may be disposable or may be recharged via an inductive charging interface 610 when not in use where the charging interface 610 provides a means to charge the battery 608 without intrusion into the enclosure 602. In certain other embodiments, electrical contacts may be provided in the enclosure 602 to facilitate charging of the battery 608. Battery capacity should be large enough that the interface module 516 is powered during a complete canning process. Certain exemplary embodiments may be configured to communicate battery status via the same communication method as is used by the interface module 516 to communicate with receivers. Certain exemplary embodiments comprise a transmitter 612. In such embodiments, the transmitter 612 is used to transmit temperature and possibly other data to a receiver. Communications methods comprise radio frequency, sound transmission, magnetic field variation, and other transmission methods suitable for transmission from within a canner 702 such as illustrated in FIG. 7.

FIG. 7 illustrates a canning process 700 in which jar temperatures are monitored by an exemplary embodiment. As shown, a pressure canner 702 is placed on a heat source 704. Enclosed by the pressure canner 702 are three canning jar assemblies 706 which include interface modules 708 and jar lids configured with probes 710. When in use, a user processes the foodstuffs as would be done when following an ordinary canning process. The jar lids with probes 710 are installed on the canning jars and the interface modules 708 are mounted to each canning jar assembly 706. It should be noted that FIG. 7 illustrates only three canning jar assemblies 706 for sake of clarity. Pressure canners routinely house larger numbers of canning jars during the canning process and thus, it is not the intention of the inventor to limit the invention to only small numbers of canning jars. In certain exemplary embodiments, interface modules can be applied to fewer than the total number of canning jars located in a pressure canner 702.

Referring again to FIG. 7, as illustrated, the interface modules 708 communicate to a receiver 712 located adjacent to the pressure canner 702. As was discussed herein, the means of communication can involve methods such as radio frequency communications, sound communications, magnetic pulse communications, and other technologies that can penetrate the pressure canner 702 in order to communicate with a receiver 712. In certain exemplary embodiments, the receiver is a smartphone, tablet, or other device with a user interface 714. In such embodiments, an application program (App) can be installed on the receiver 712. The receiver 712 collects temperature data from the various interface modules 708, and using timers and prompts, the application program provides instructions to a user that enables the user to safely perform various canning processes.

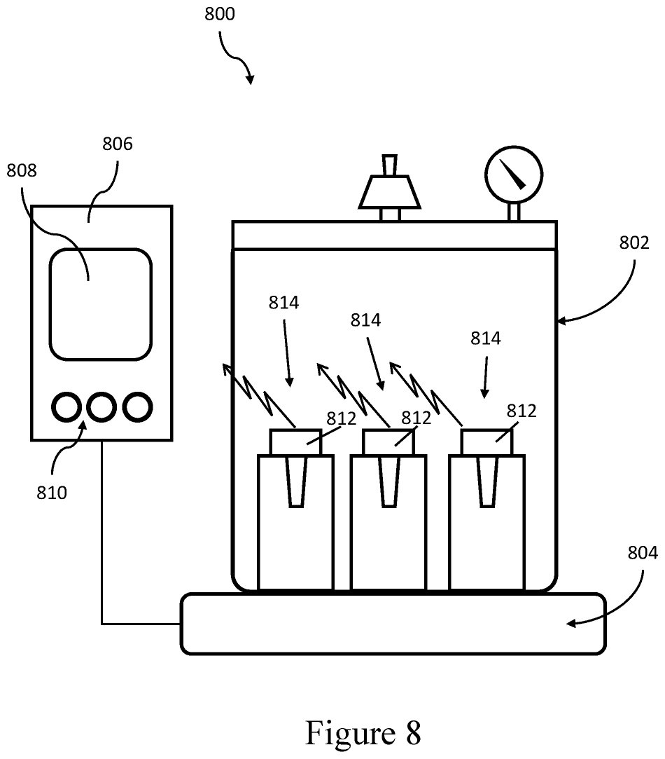

While the exemplary embodiment illustrated in FIG. 7 utilizes a conventional pressure canner 702 and heat source 704, other exemplary embodiments may utilize canning systems in which the heat source and receiver are integrated into a single appliance. An example of such an embodiment is illustrated in FIG. 8. In an exemplary embodiment 800, a pressure canner 802 is placed on a heat source 804. As shown, the heat source 804 is in electronic communication with a controller/receiver 806. In an exemplary embodiment, the controller/receiver 806 includes a display 808 and input controls 810. In a configuration similar to FIG. 7, the controller/receiver 806 receives temperature information from one or more interface modules 812 located at canning jar assemblies 814. In the illustrated embodiment the controller/receiver 806 communicates control information to the heat source 804 such that the temperature of the heat source is regulated in compliance with the requirements of the foodstuffs that are to be canned by the canning jar assemblies 814. The controller/receiver 806 of FIG. 8 adjusts the temperature of the heat source 804 such that the measured temperatures of the foodstuffs are maintained at levels required by a recipe selected by the user. As is illustrated, the pressure canner 802 used is a conventional canner such that a user can utilize canners that they may already own. In still other exemplary embodiments, the canner, heat source and controller/receiver may be integrated into a single appliance. In such exemplary embodiments, additional functionality may be gained by using the controller/receiver 806 to interact with pressure regulators, additional temperature sensors, or lid locks. Thus, as will be understood by one of ordinary skill in the art, the ability to monitor temperatures at each canning jar may allow for more precise regulation of the canning process to achieve better tasting and safer canned foods.

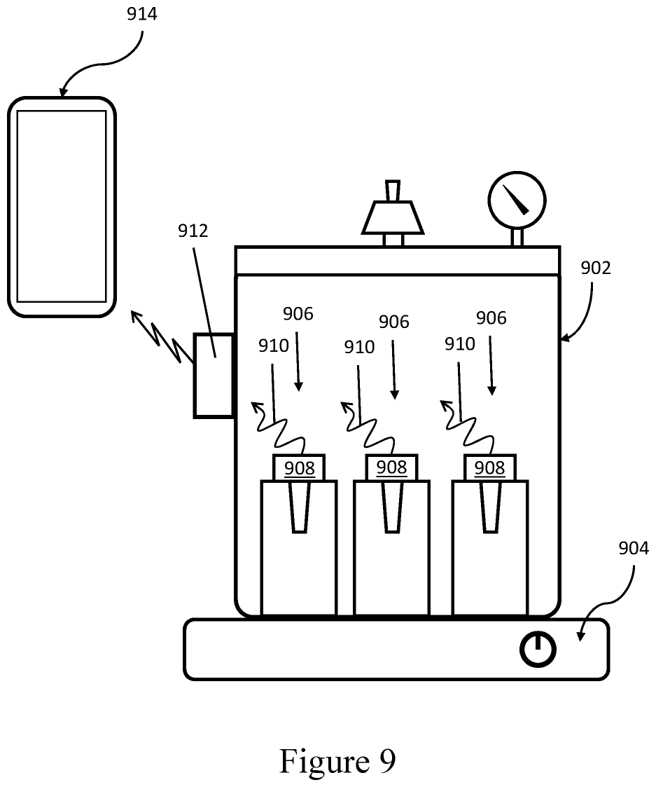

FIG. 9 illustrates another exemplary embodiment in which sound waves are used to transmit temperature information out of the canner 902. Shown is a canner 902, a heat source 904. canning jars and lids 906, each with an interface module 908 attached to lid as described earlier herein. In the illustrated embodiment, the interface module 908 comprises a transducer that creates sound pulses 910 which are transmitted through a steam-filled environment inside the canner 902 to a sound receiver 912. As illustrated, the sound receiver 912 may be mounted in contact with the canner 902 to allow for receipt of the sound pulses 910 through the body of the canner 902. In alternative embodiments, the sound receiver 912 may be mounted such that it not in direct contact with the canner 902, for instance, certain embodiments may be mounted with a heat insulating material located between the sound receiver 912 and the body of the canner 902. Other embodiments may the utilize a sound sensor in contact with the canner 902 while the bulk of the sound receiver 912 is thermally isolated from the body of the canner 902 to prevent damage to the sound receiver 912.

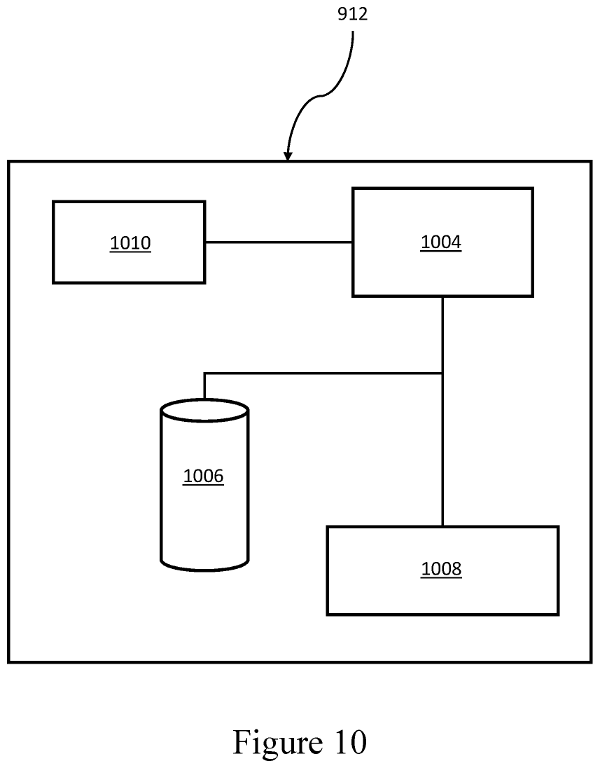

FIG. 10 illustrates an exemplary sound receiver 912 which comprises a processor 1004, a battery 1006, a sound sensor 1008, and a transmitter 1010. As was described in the discussion of FIG. 9, the sound sensor 1008 receives sound pulses 910 which communicate temperatures sensed within the canning jars. The received sound pulses 910 are processes by the processor 1004 and transmitted by the transmitter 1010 to a receiver such as 914 as illustrated in FIG. 9. As shown, the sound receiver 912 comprises a source of power such as a battery 1006 to energize the processor 1004, the sound sensor 1008, and the transmitter 1010. Exemplary embodiments of a sound receiver 912 may also comprise display and control elements (not shown) to enable a user to turn the sound receiver 912 on and off, check the status of the sound receiver 912, or perform other setup and monitoring functions. Thus, in the illustrated embodiment, the sound receiver 912 serves to facilitate communication between interface modules 908 which transmit temperature information via sound pulses 910 and the receiver 914 which is configured to receive radio frequency signals such as provided by the transmitter 1010.

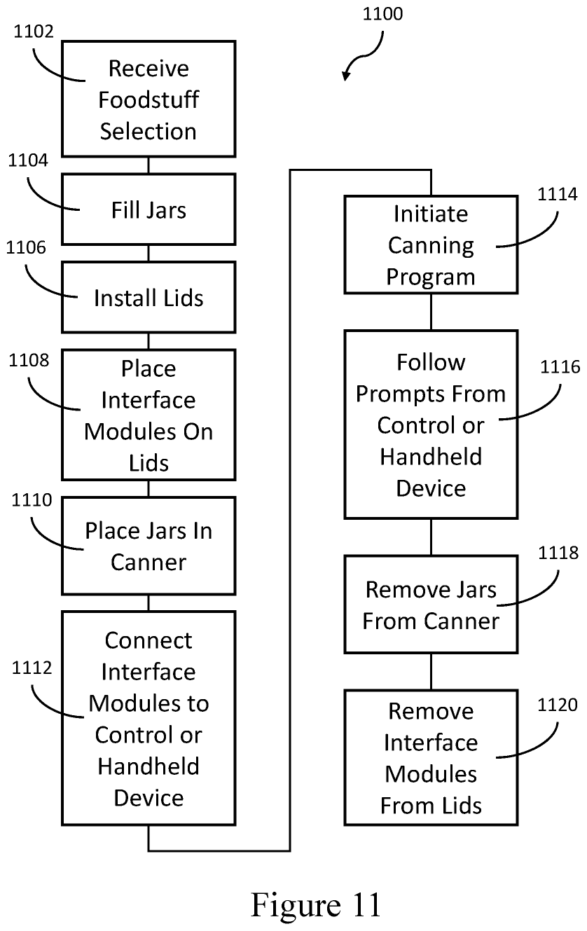

An example of the process canning process using an exemplary embodiment as disclosed herein is described in the flow diagram 1100 of FIG. 11. The flow diagram 1100 illustrates operations performed by a user in accordance with an illustrative embodiment. In alternative embodiments, additional, fewer, and/or different operations may be performed. Further, the use of a flow diagram is not meant to be limiting with respect to the order of operations performed. The flow diagram 1100 refers to the exemplary system illustrated in FIG. 7 but could equally apply other exemplary systems. In step 1102 the receiver 712 receives a selection from the user that identifies the type of foodstuffs being canned. In step 1104 the display shows a message prompting the user to perform any pre-processing steps (such as preheat canning jars), and fill the jars to a correct level. The user then installs the jar lids in step 1106 and places interface modules 708 on the lids in step 1108. The jars are placed in the canner in step 1110 and in step 1112, the interface modules 708 are connected electronically to the receiver 712. In such a step, a user may cause the interface modules to transmit an identifying code such that the receiver 712 learns the identity of each interface module 708 in communication with the receiver 712. The receiver 712 also determines the number of interface modules 708 connected to the receiver 712. In certain exemplary embodiments, the receiver monitors the interface modules 708 and the temperatures reported by each interface module 708 and determines recipe temperatures at points in the canning process by taking the lowest temperature in circumstances in which the temperature represents a “heat to” setpoint and takes the highest temperature in circumstances in which the temperature represents a “cool to” setpoint. Thus, exemplary embodiments ensure that all jars in a canner achieve required temperatures before proceeding to the next step in a canning process. In step 1114, the receiver 712 initiates the canning process. In embodiments such as illustrated in FIG. 7, this likely means that the user is prompted to apply heat to a canner, the receiver 712 then starts timing a portion of the process. As the canning process proceeds, the user is prompted by messages displayed by the receiver 712 in step 1116 to perform various actions. For example, a user may be prompted to adjust the heat applied to a canner. The receiver 712 may then monitor canning jar temperatures reported by the various interface modules 708 and prompt the user to place a pressure regulator on the canner once measured temperatures reach a certain desired temperature. In another embodiment, the user may be prompted to touch a prompt on the user interface 714 of the receiver 712 when steam is observed exiting the canner. In such an embodiment, the receiver may start a timer and after a predetermined period of time, prompt the user to place a pressure regulator on the canner. In such an embodiment the user acknowledges that the pressure regulator was placed on the canner and the receiver 712 continues implementing timers and prompting the user to perform actions as required to safely can the selected foodstuff. When the canning process is complete the receiver prompts the user to remove the jars from the canner in step 1118. In step 1120 the user removes the interface modules 708 from the lids, leaving the jars sealed for storage and freeing the interface modules 708 for cleaning, charging, and reuse.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

For purposes of interpreting the claims, it is expressly intended that the provisions of 35 U.S.C. § 112(f) are not to be invoked unless the specific terms “means for” or “step for” are recited in a claim.

Coupled elements can be electrically, magnetically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below”) are merely used to describe the orientation of various elements in the Figures. The orientation of various elements may differ according to other exemplary embodiments, and that such variations are intended to be encompassed by the present disclosure.

What is claimed is:

1. A system for canning foodstuffs comprising:
ajar lid;
a probe chamber affixed to the jar lid;
an interface module; and
a receiver;
the interface module being in electrical communication with a temperature sensor disposed in the probe chamber, a signal transmitted by the interface module transmitting a signal comprising temperature data;
the receiver comprising a processor and instructions that when executed by the processor, cause the processor to:
receive the signal from the interface module;
process the received signal to determine a temperature detected by the temperature sensor; and
display the determined temperature.

2. The system of claim 1, further comprising instructions which cause the processor to:
determine if the received temperature is within a desired temperature range; and
display a user prompt on a user interface which indicates an action to perform in a canning process.

3. The system of claim 2, wherein the instructions further cause the processor to:
cause a series of steps to be displayed on the user interface where the steps are dependent upon one or more timers and the received temperature.

4. The system of claim 1, wherein the signal transmitted by the interface module is a radio frequency signal.

5. The system of claim 1, wherein the signal transmitted by the interface module is a sound.

6. The system of claim 5 further comprising a sound receiver, the sound receiver comprising:
a sound detector;
a processor;
a radio frequency transmitter;
the processor comprising instructions that when executed, cause the processor to receive sound data representing temperature data and transmit the temperature data using the radio frequency transmitter such that the signal received by the receiver of the system is sound data converted to radio frequency data by the sound receiver.

7. The device of claim 1, wherein the jar lid comprises an upper and lower surface and the probe chamber extends axially from the lower surface of the jar lid.

8. The device of claim 1, wherein the probe chamber is a separate component affixable to the jar lid.

9. The device of claim 1, wherein the interface module comprises a magnet adapted to removably affix the interface module to the jar lid.

10. The device of claim 1, wherein the interface module comprises a screw band adapted to affix the interface module to a canning jar.

11. The device of claim 1, wherein the interface module comprises a rechargeable battery and an inductive receiver in electrical communication with a battery charging electronic circuit which charges the battery.

12. The device of claim 7, wherein the probe chamber is formed such that a probe chamber of a first jar lid is insertable into a probe chamber of a second jar lid to enable stacking of the first and second jar lids for storage.

13. A method of canning comprising the steps of:
applying a jar lid to a canning jar, the jar lid comprising a probe chamber having a temperature sensor disposed therein;
applying an interface module to the jar lid;
causing the interface module to be in electronic communication with a receiver, the receiver comprising a user interface;
receiving temperature sensor data by the interface module;
transmitting the received temperature sensor data by the interface module;
receiving the transmitted temperature data by the receiver; and
displaying, using the user interface, temperatures represented by the temperature data.

14. The method of claim 13, further comprising the step of displaying messages using the user interface where such messages are determined by the temperature data and time data and related to a canning process.

15. The method of claim 14, wherein the messages comprise steps in the canning process.

16. The method of claim 13, further comprising the steps of controlling a heat source configured to apply heat to an enclosure in which the canning jar, jar lid, and interface module are disposed.

17. The method of claim 16, wherein the receiver provides controlling instructions to a heat source which applies heat to the enclosure.

18. A system for canning foodstuffs comprising:
a jar lid comprising an upper surface and a lower surface with a probe chamber affixed to the jar lid, the probe chamber extending axially from the lower surface of the jar lid;
an interface module which comprises a processor, a transmitter, and a battery, the interface module removably affixable to the jar lid and in electrical communication with a temperature sensor disposed in the probe chamber, the interface module comprising instructions that cause the processor to transmit a signal using the transmitter, the signal comprising temperature data from the temperature sensor;
a receiver, the receiver comprising a processor and instructions that when executed by the processor, cause the processor to:
receive the signal from the interface module;
process the received signal to determine a temperature detected by the temperature sensor;
determine if the received temperature is within a desired temperature range; and
display a series of steps on a user interface which indicates an action to perform in a canning process where the displayed steps are dependent upon one or more timers and the received temperature.

19. The system of claim 18, wherein the signal transmitted by the interface module is a radio frequency signal.

20. The system of claim 18 wherein the signal transmitted by the interface module is a sound, the system further comprising a sound receiver, the sound receiver comprising:
a sound detector;
a processor;
a radio frequency transmitter;
the processor comprising instructions that when executed, cause the processor to receive sound data representing temperature data and transmit the temperature data using the radio frequency transmitter such that the signal received by the receiver of the system is sound data converted to radio frequency data by the sound receiver.
